(19) United States
(12) Patent Application Publication
(10) Pub. No.: US 2025/0063434 A1
(43) Pub. Date: Feb. 20, 2025

(54) APPARATUS, SYSTEM, AND METHOD OF CONFIGURING A CHANNEL BANDWIDTH FOR WIRELESS COMMUNICATION

(71) Applicant: Intel Corporation, Santa Clara, CA (US)

(72) Inventors: Oded Liron, Haifa (IL); Eran Segev, Tel Aviv (IL); Danny Alexander, Monoson (IL); Omer Ytzhaki, Haifa (IL); Hila Ben Artzi, Herzliya (IL)

(73) Assignee: Intel Corporation, Santa Clara, CA (US)

(21) Appl. No.: 18/399,342

(22) Filed: Dec. 28, 2023

Related U.S. Application Data
(60) Provisional application No. 63/520,203, filed on Aug. 17, 2023.

(51) Int. Cl. H04W 28/20

(52) U.S. Cl. CPC H04W 28/20

(57) ABSTRACT

For example, a wireless communication station (STA) may be configured to determine a usage-based channel Bandwidth (BW) setting, for example, based on a link-usage parameter corresponding to a usage of a wireless communication link for communication of traffic between the STA and an Access Point (AP). For example, the STA may be configured to transmit a channel BW reduction request to the AP, for example, based on a determination that the usage-based channel BW setting is less than an operating channel BW setting for the STA. For example, the channel BW reduction request may be configured to request the AP to reduce the operating channel BW setting for the STA based on the usage-based channel BW setting.

### CROSS REFERENCE

This application claims the benefit of and priority from U.S. Provisional Patent Application No. 63/520,203 entitled “APPARATUS, SYSTEM, AND METHOD OF CONFIGURING A CHANNEL BANDWIDTH FOR WIRELESS COMMUNICATION”, filed Aug. 17, 2023, the entire disclosure of which is incorporated herein by reference.

### BACKGROUND

Devices in a wireless communication system may be configured to communicate transmissions over various channel bandwidths.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of a method of configuring a channel bandwidth for wireless communication, in accordance with some demonstrative aspects.

FIG. 3 is a schematic illustration of a method of configuring a channel bandwidth for wireless communication, in accordance with some demonstrative aspects.

FIG. 4 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2020 (IEEE 802.11-2020, IEEE Standard for Information Technology—Telecommunications and Information Exchange between Systems Local and Metropolitan Area Networks—Specific Requirements; Part 11: Wireless LAN Medium Access Control (MAC) and Physical Layer (PHY) Specifications, December 2020); and/or IEEE 802.11be (IEEE P802.11be/D5.0 Draft Standard for Information technology—Telecommunications and information exchange between systems Local and metropolitan area networks—Specific requirements; Part 11: Wireless LAN Medium Access Control (MAC) and Physical Layer (PHY) Specifications; Amendment 8: Enhancements for extremely high throughput (EHT), November 2023)) and/or future versions and/or derivatives thereof, devices and/or networks operating in accordance with existing cellular specifications and/or protocols, and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™ Ultra-Wideband (UWB), 4G, Fifth Generation (5G), or Sixth Generation (6G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that may be integrated with a computer, or a peripheral that may be attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated or group), and/or memory (shared. Dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects may be used in conjunction with a WLAN, e.g., a WiFi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub-10 Gigahertz (GHz) frequency band, for example, a 2.4 GHz frequency band, a 5 GHz frequency band, a 6 GHz frequency band, and/or any other frequency band below 10 GHz.

Some demonstrative aspects may be used in conjunction with a wireless communication network communicating over an Extremely High Frequency (EHF) band (also referred to as the “millimeter wave (mmWave)” frequency band), for example, a frequency band within the frequency band of between 20 Ghz and 300 GHz, for example, a frequency band above 45 GHz, e.g., a 60 GHz frequency band, and/or any other mmWave frequency band. Some demonstrative aspects may be used in conjunction with a wireless communication network communicating over the sub-10 GHz frequency band and/or the mmWave frequency band, e.g., as described below. However, other aspects may be implemented utilizing any other suitable wireless communication frequency bands, for example, a 5G frequency band, a frequency band below 20 GHz, a Sub 1 GHz (S1G) band, a WLAN frequency band, a WPAN frequency band, and the like.

Some demonstrative aspects may be implemented by an mmWave STA (mSTA), which may include for example, a STA having a radio transmitter, which is capable of operating on a channel that is within the mmWave frequency band. In one example, mmWave communications may involve one or more directional links to communicate at a rate of multiple gigabits per second, for example, at least 1 Gigabit per second, e.g., at least 7 Gigabit per second, at least 30 Gigabit per second, or any other rate.

In some demonstrative aspects, the mmWave STA may include a Directional Multi-Gigabit (DMG) STA, which may be configured to communicate over a DMG frequency band. For example, the DMG band may include a frequency band wherein the channel starting frequency is above 45 GHZ.

In some demonstrative aspects, the mmWave STA may include an Enhanced DMG (EDMG) STA, which may be configured to implement one or more mechanisms, which may be configured to enable Single User (SU) and/or Multi-User (MU) communication of Downlink (DL) and/or Uplink frames (UL) using a MIMO scheme. For example, the EDMG STA may be configured to implement one or more channel bonding mechanisms, which may, for example, support communication over a channel bandwidth (BW) (also referred to as a “wide channel”, an “EDMG channel”, or a “bonded channel”) including two or more channels, e.g., two or more 2.16 GHz channels. For example, the channel bonding mechanisms may include, for example, a mechanism and/or an operation whereby two or more channels, e.g., 2.16 GHZ channels, can be combined, e.g., for a higher bandwidth of packet transmission, for example, to enable achieving higher data rates, e.g., when compared to transmissions over a single channel. Some demonstrative aspects are described herein with respect to communication over a channel BW including two or more 2.16 GHz channels, however other aspects may be implemented with respect to communications over a channel bandwidth, e.g., a “wide” channel, including or formed by any other number of two or more channels, for example, an aggregated channel including an aggregation of two or more channels. For example, the EDMG STA may be configured to implement one or more channel bonding mechanisms, which may, for example, support an increased channel bandwidth, for example, a channel BW of 4.32 GHZ, a channel BW of 6.48 GHz, a channel BW of 8.64 GHZ, and/or any other additional or alternative channel BW. The EDMG STA may perform other additional or alternative functionality.

In other aspects, the mmWave STA may include any other type of STA and/or may perform other additional or alternative functionality. Other aspects may be implemented by any other apparatus, device and/or station.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

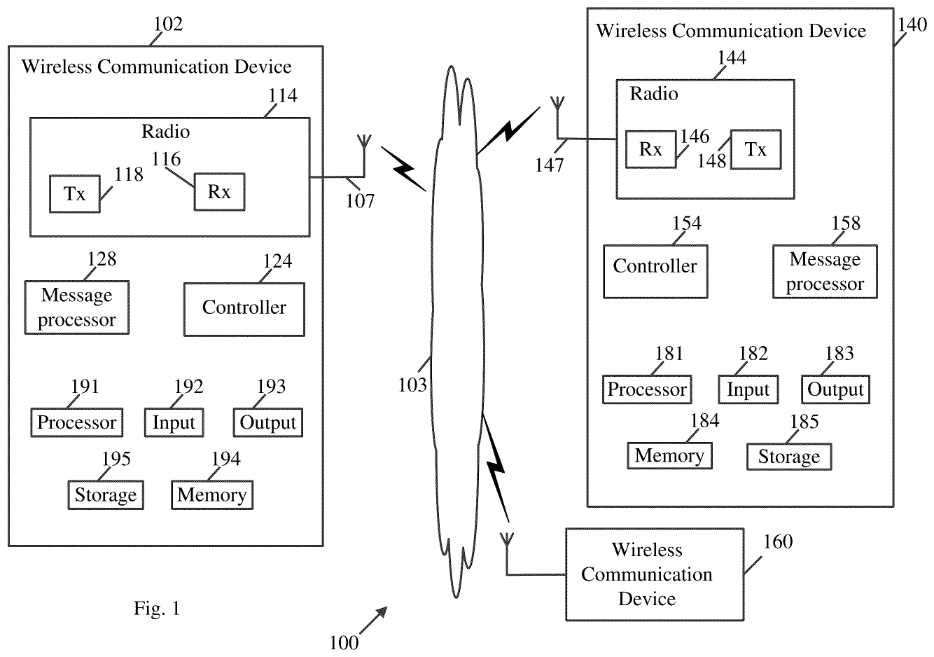

Reference is made to FIG. 1, which schematically illustrates a system 100, in accordance with some demonstrative aspects.

As shown in FIG. 1, in some demonstrative aspects, system 100 may include one or more wireless communication devices. For example, system 100 may include a wireless communication device 102, a wireless communication device 140, a wireless communication device 160, and/or one more other devices.

In some demonstrative aspects, devices 102, 140, and/or 160 may include a mobile device or a non-mobile, e.g., a static, device.

For example, devices 102, 140, and/or 160 may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player or the like.

In some demonstrative aspects, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative aspects, some or all of the components of one or more of devices 102 and/or 140 may be enclosed in a common housing or packaging, and may be interconnected or operably associated using one or more wired or wireless links. In other aspects, components of one or more of devices 102 and/or 140 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an Operating System (OS) of device 140 and/or of one or more suitable applications.

In some demonstrative aspects, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a disk drive, a solid-state drive (SSD), and/or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102, 140, and/or 160 may be capable of communicating content, data, information and/or signals via a wireless medium (WM) 103. In some demonstrative aspects, wireless medium 103 may include, for example, a radio channel, an RF channel, a WiFi channel, a cellular channel, a 5G channel, an IR channel, a Bluetooth (BT) channel, a Global Navigation Satellite System (GNSS) Channel, and the like.

In some demonstrative aspects, WM 103 may include one or more wireless communication frequency bands and/or channels. For example, WM 103 may include one or more channels in a sub-10 Ghz wireless communication frequency band, for example, a 2.4 GHz wireless communication frequency band, one or more channels in a 5 GHz wireless communication frequency band, and/or one or more channels in a 6 GHz wireless communication frequency band. In another example, WM 103 may additionally or alternatively include one or more channels in an mmWave wireless communication frequency band. In other aspects, WM 103 may include any other type of channel over any other frequency band.

In some demonstrative aspects, device 102, device 140, and/or device 160 may include one or more radios including circuitry and/or logic to perform wireless communication between devices 102, 140, 160, and/or one or more other wireless communication devices. For example, device 102 may include one or more radios 114, and/or device 140 may include one or more radios 144.

In some demonstrative aspects, radios 114 and/or radios 144 may include one or more wireless receivers (Rx) including circuitry and/or logic to receive wireless communication signals, RF signals, frames, blocks, transmission streams, packets, messages, data items, and/or data. For example, a radio 114 may include at least one receiver 116, and/or a radio 144 may include at least one receiver 146.

In some demonstrative aspects, radios 114 and/or 144 may include one or more wireless transmitters (Tx) including circuitry and/or logic to transmit wireless communication signals, RF signals, frames, blocks, transmission streams, packets, messages, data items, and/or data. For example, a radio 114 may include at least one transmitter 118, and/or a radio 144 may include at least one transmitter 148.

In some demonstrative aspects, radios 114 and/or 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radios 114 and/or 144 may include or may be implemented as part of a wireless Network Interface Card (NIC), and the like.

In some demonstrative aspects, radios 114 and/or 144 may be configured to communicate over a 2.4 GHz band, a 5 GHz band, a 6 GHz band, and/or any other band, for example, a directional band, e.g., an mmWave band, a 5G band, an SIG band, and/or any other band.

In some demonstrative aspects, radios 114 and/or 144 may include, or may be associated with one or more antennas.

In some demonstrative aspects, device 102 may include one or more antennas 107, and/or device 140 may include on or more antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. In some aspects, antennas 107 and/or 147 may implement transmit and receive functionalities using separate transmit and receive antenna elements. In some aspects, antennas 107 and/or 147 may implement transmit and receive functionalities using common and/or integrated transmit/receive elements.

In some demonstrative aspects, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140, 160 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140, 160 and/or one or more other devices, e.g., as described below.

In some demonstrative aspects, controllers 124 and/or 154 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein. In one example, controller 154 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, at least part of the functionality of controller 124 may be implemented as part of one or more elements of radio 114, and/or at least part of the functionality of controller 154 may be implemented as part of one or more elements of radio 144.

In other aspects, the functionality of controller 124 may be implemented as part of any other element of device 102, and/or the functionality of controller 154 may be implemented as part of any other element of device 140.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or more messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, message processors 128 and/or 158 may include, or may be implemented, partially or entirely, by circuitry and/or logic, e.g., one or more processors including circuitry and/or logic, memory circuitry and/or logic, MAC circuitry and/or logic, PHY circuitry and/or logic, BB circuitry and/or logic, a BB processor, a BB memory, AP circuitry and/or logic, an AP processor, an AP memory, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative aspects, at least part of the functionality of message processor 128 may be implemented as part of radio 114, and/or at least part of the functionality of message processor 158 may be implemented as part of radio 144.

In some demonstrative aspects, at least part of the functionality of message processor 128 may be implemented as part of controller 124, and/or at least part of the functionality of message processor 158 may be implemented as part of controller 154.

In other aspects, the functionality of message processor 128 may be implemented as part of any other element of device 102, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of one or more radios 114. For example, the chip or SoC may include one or more elements of controller 124, one or more elements of message processor 128, and/or one or more elements of one or more radios 114. In one example, controller 124, message processor 128, and one or more radios 114 may be implemented as part of the chip or SoC.

In other aspects, controller 124, message processor 128 and/or one or more radios 114 may be implemented by one or more additional or alternative elements of device 102.

In some demonstrative aspects, at least part of the functionality of controller 154 and/or message processor 158 may be implemented by an integrated circuit, for example, a chip, e.g., a SoC. In one example, the chip or SoC may be configured to perform one or more functionalities of one or more radios 144. For example, the chip or SoC may include one or more elements of controller 154, one or more elements of message processor 158, and/or one or more elements of one or more radios 144. In one example, controller 154, message processor 158, and one or more radios 144 may be implemented as part of the chip or SoC.

In other aspects, controller 154, message processor 158 and/or one or more radios 144 may be implemented by one or more additional or alternative elements of device 140.

In some demonstrative aspects, device 102, device 140, and/or device 160 may include, operate as, perform the role of, and/or perform one or more functionalities of, one or more STAs. For example, device 102 may include at least one STA, device 140 may include at least one STA, and/or device 160 may include at least one STA.

In some demonstrative aspects, device 102, device 140, and/or device 160 may include, operate as, perform the role of, and/or perform one or more functionalities of, one or more Extremely High Throughput (EHT) STAs. For example, device 102 may include, operate as, perform the role of, and/or perform one or more functionalities of, one or more EHT STAs, and/or device 140 may include, operate as, perform the role of, and/or perform one or more functionalities of, one or more EHT STAs.

In some demonstrative aspects, for example, device 102, device 140, and/or device 160 may be configured to perform one or more operations, and/or functionalities of a WiFi 8 STA.

In other aspects, for example, devices 102, 140 and/or 160 may be configured to perform one or more operations, and/or functionalities of an Ultra High Reliability (UHR) STA.

In other aspects, for example, devices 102, 140, and/or 160 may be configured to perform one or more operations, and/or functionalities of any other additional or alternative type of STA.

In other aspects, device 102, device 140, and/or device 160 may include, operate as, perform the role of, and/or perform one or more functionalities of, any other wireless device and/or station, e.g., a WLAN STA, a WiFi STA, and the like.

In some demonstrative aspects, device 102, device 140, and/or device 160 may be configured operate as, perform the role of, and/or perform one or more functionalities of, an Access Point (AP), e.g., a High Throughput (HT) AP STA, a High Efficiency (HE) AP STA, an EHT AP STA and/or a UHR AP STA.

In some demonstrative aspects, device 102, device 140, and/or device 160 may be configured to operate as, perform the role of, and/or perform one or more functionalities of, a non-AP STA, e.g., an HT non-AP STA, an HE non-AP STA, an EHT non-AP STA and/or a UHR non-AP STA.

In other aspects, device 102, device 140, and/or device 160 may operate as, perform the role of, and/or perform one or more functionalities of, any other additional or alternative device and/or station.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains one station (STA) and provides access to the distribution services, via the wireless medium (WM) for associated STAs. An AP may include a STA and a distribution system access function (DSAF). The AP may perform any other additional or alternative functionality.

In some demonstrative aspects devices 102, 140, and/or 160 may be configured to communicate in an HT network, an HE network, an EHT network, a UHR network, and/or any other network.

In some demonstrative aspects, devices 102, 140 and/or 160 may be configured to operate in accordance with one or more Specifications, for example, including one or more IEEE 802.11 Specifications, and/or any other specification and/or protocol.

In some demonstrative aspects, device 102 may include, operate as, perform a role of, and/or perform the functionality of, an AP STA.

In some demonstrative aspects, device 140, and/or device 160 may include, operate as, perform a role of, and/or perform the functionality of, one or more non-AP STAs. For example, device 140 may include, operate as, perform a role of, and/or perform the functionality of, at least one non-AP STA, and/or device 160 may include, operate as, perform a role of, and/or perform the functionality of, at least one non-AP STA.

In some demonstrative aspects, device 102, device 140, and/or device 160 may include, operate as, perform a role of, and/or perform the functionality of, a Multi-Link Device (MLD). For example, device 102 may include, operate as, perform a role of, and/or perform the functionality of, at least one MLD, device 140 may include, operate as, perform a role of, and/or perform the functionality of, at least one MLD, and/or device 160 may include, operate as, perform a role of, and/or perform the functionality of, at least one MLD, e.g., as described below.

For example, an MLD may include a device that is a logical entity that is capable of supporting more than one affiliated station (STA) and can operate using one or more affiliated STAs. For example, the MLD may present one Medium Access Control (MAC) data service and a single MAC Service Access Point (SAP) to the Logical Link Control (LLC) sublayer. The MLD may perform any other additional or alternative functionality.

In some demonstrative aspects, for example, an infrastructure framework may include a multi-link AP logical entity, which includes APs, e.g., on one side, and a multi-link non-AP logical entity, which includes non-APs, e.g., on the other side.

In some demonstrative aspects, device 102, device 140, and/or device 160 may be configured to operate as, perform the role of, and/or perform one or more functionalities of, an AP MLD.

In some demonstrative aspects, device 102, device 140, and/or device 160 may be configured to operate as, perform the role of, and/or perform one or more functionalities of, a non-AP MLD.

In other aspects, device 102, device 140, and/or device 160 may operate as, perform the role of, and/or perform one or more functionalities of, any other additional or alternative device and/or station.

For example, an AP MLD may include an MLD, where each STA affiliated with the MLD is an AP. In one example, the AP MLD may include a multi-link logical entity, where each STA within the multi-link logical entity is an EHT AP. The AP MLD may perform any other additional or alternative functionality.

For example, a non-AP MLD may include an MLD, where each STA affiliated with the MLD is a non-AP STA. In one example, the non-AP MLD may include a multi-link logical entity, where each STA within the multi-link logical entity is a non-AP EHT STA. The non-AP MLD may perform any other additional or alternative functionality.

In some demonstrative aspects, device 102, device 140, and/or device 160 may be configured to support communication over a plurality of channel bandwidths (BWs) (also referred to as “channel widths”), e.g., as described below.

In some demonstrative aspects, device 102, device 140, and/or device 160 may be configured to support communication over channel widths of 20 MHz, 40 MHz, 80 MHz, 160 MHz and 320 MHz, e.g., in accordance with one or more IEEE 802.11 Specifications.

In some demonstrative aspects, device 102, device 140, and/or device 160 may be configured to support communication over each of the channel widths of 20 MHz, 40 MHz, 80 MHz, 160 MHz and 320 MHz.

In some demonstrative aspects, device 102, device 140, and/or device 160 may be configured to support communication over some of the channel widths of 20 MHz, 40 MHz, 80 MHz, 160 MHz and 320 MHz.

In other aspects, device 102, device 140, and/or device 160 may be configured to support communication over any other additional or alternative channel widths, e.g., including any suitable punctured channels, Resource Units (RUs), Multi Resource Units (MRUs), and/or any other type of channel width and/or channel allocation.

In some demonstrative aspects, device 102, device 140, and/or device 160 may be configured to implement one or more operations and/or functionalities of a channel BW configuration mechanism to configure a channel BW for wireless communication, e.g., as described below.

In some demonstrative aspects, for example, in some use cases and/or scenarios, it may be preferred to configure a STA to operate over a higher channel width, e.g., a highest possible channel width, for example, to allow the STA to reach higher, e.g., maximum, throughputs, and/or to increase an overall capacity of a Basic Service Set (BSS) to which the STA belongs.

However, a power consumption, e.g., a Wi-Fi modem power consumption, of the STA may increase, e.g., as the operating channel width increases. For example, operating in higher channel widths may require Hardware (HW) processing of a received signal, e.g., with higher sample rates, and/or may require having the hardware prepared to receive and process the highest possible throughput, e.g., at any time.

In some demonstrative aspects, for example, in some use cases and/or scenarios, a STA may not need to utilize a high channel bandwidth, e.g., as described below.

In some demonstrative aspects, for example, in some use cases and/or scenarios, a reduced channel bandwidth may be sufficient to support communication of traffic of the STA, e.g., as described below.

In some demonstrative aspects, for example, in some use cases and/or scenarios, operating a STA in a channel bandwidth that is higher than the STA actually needs may waste device power.

For example, a power consumption of a STA performing wireless communication of data of some applications, e.g., an online meeting application, may be reduced, for example, by reducing the channel width.

In one example, a frequency domain signal processing power consumption of the STA may be reduced by about 50%, for example, by reducing the operating BW by half, e.g., from 320 MHz to 160 MHz.

In one example, a frequency domain signal processing power consumption of the STA may be reduced by about 75%, for example, by reducing the operating BW by 75%, e.g., from 320 MHz to 80 MHz.

In one example, a frequency domain signal processing power consumption of the STA may be reduced by about 87.5%, for example, by reducing the operating BW by 87.5, e.g., from 320 MHz to 40 MHz.

In some demonstrative aspects, device 102, device 140, and/or device 160 may be configured to implement one or more operations and/or functionalities of a channel BW configuration mechanism, which may be configured to provide a technical solution to support configuring a channel width for a STA, for example, based on one or more channel-width selection criteria, e.g., as described below.

In some demonstrative aspects, a STA, e.g., a STA implemented by device 102, device 140, and/or device 160, may implement the channel BW configuration mechanism, for example, to select, e.g., to dynamically select, an operating channel width for the STA, e.g., as descried below.

In some demonstrative aspects, the channel BW configuration mechanism may be configured to select, e.g., to dynamically select, the operating channel width for the STA, for example, based on one or more link-usage parameters corresponding to the STA, e.g., as descried below.

In some demonstrative aspects, the one or more link-usage parameters corresponding to the STA may include one or more link-usage parameters corresponding to a usage of a wireless communication link for communication of traffic of the STA, e.g., as described below.

In some demonstrative aspects, the one or more link-usage parameters corresponding to the STA may include one or more link-usage parameters corresponding to a usage of a wireless communication link for communication of traffic between the STA and an AP, e.g., as described below.

In some demonstrative aspects, the one or more link-usage parameters corresponding to the STA may include one or more link-usage parameters corresponding to a usage of a wireless communication link for transmission of traffic from the STA, and/or for reception of traffic by the STA, e.g., as described below.

In some demonstrative aspects, the channel BW configuration mechanism may be configured to select, e.g., to dynamically select, the operating channel width for the STA, for example, based on one or more characteristics and/or requirements of traffic to be communicated, e.g., transmitted and/or received, by the STA, e.g., as descried below.

In some demonstrative aspects, the channel BW configuration mechanism may be configured to select, e.g., to dynamically select, the operating channel width for the STA, for example, based on one or more characteristics and/or requirements of a traffic pattern to be communicated by the STA, e.g., as descried below.

In some demonstrative aspects, the channel BW configuration mechanism may be configured to select, e.g., to dynamically select, the operating channel width for the STA, for example, based on one or more characteristics and/or requirements of an application for which the traffic is to be communicated by the STA, e.g., as descried below.

In some demonstrative aspects, the channel BW configuration mechanism may be configured to select, e.g., to dynamically select, the operating channel width for the STA to include, for example, a lowest channel width that may still support one or more requirements for communication of the traffic of the STA, e.g., as described below.

In some demonstrative aspects, controller 154 may be configured to control, trigger, cause, and/or instruct a STA implemented by device 140 to determine a usage-based channel BW setting, for example, based on a link-usage parameter corresponding to a usage of a wireless communication link for communication of traffic between the STA and an AP, for example, an AP implemented by device 102, e.g., as described below.

In some demonstrative aspects, controller 154 may be configured to control, trigger, cause, and/or instruct the STA implemented by device 140 to transmit a channel BW reduction request to the AP, for example, based on a determination that the usage-based channel BW setting is less than an operating channel BW setting for the STA, e.g., as descried below.

In some demonstrative aspects, the channel BW reduction request may be configured to request the AP to reduce the operating channel BW setting for the STA, for example, based on the usage-based channel BW setting, e.g., as described below.

In some demonstrative aspects, the operating channel BW setting of the STA may include, for example, an AP-assigned setting of the channel BW, which may be assigned by the AP to the STA.

For example, the AP implemented by device 102 may assign the operating channel BW setting to the STA implemented by device 140, for example, in accordance with one or more procedures of an IEEE 802.11 Specification, and/or any other suitable procedure and/or protocol.

In some demonstrative aspects, controller 154 may be configured to control, trigger, cause, and/or instruct the STA implemented by device 140 to transmit a channel BW increase request to the AP, for example, based on a determination that the usage-based channel BW setting is greater than the operating channel BW setting for the STA.

In some demonstrative aspects, the channel BW increase request may be configured to request the AP to increase the operating channel BW setting for the STA based on the usage-based channel BW setting.

In some demonstrative aspects, controller 154 may be configured to control, trigger, cause, and/or instruct the STA implemented by device 140 to set the channel BW reduction request and/or the channel BW increase request, for example, by setting a channel width subfield based on the usage-based channel BW setting, and setting the channel width subfield in an Operating mode (OM) control subfield to be transmitted from the STA to the AP.

In other aspects, the channel BW reduction request and/or the channel BW increase request may be set according to any other protocol, definition, and/or format.

In some demonstrative aspects, controller 154 may be configured to control, trigger, cause, and/or instruct the STA implemented by device 140 to select the usage-based channel BW setting from a plurality of supported channel BWs, which are supported by the STA, for example, based on the link-usage parameter, e.g., as described below.

In some demonstrative aspects, the plurality of supported channel BWs comprises one or more channel BWs of a 20 MHz channel BW, a 40 MHz channel BW, an 80 MHz channel BW, a 160 MHz channel BW, and/or a 320 MHz channel BW.

In other aspects, the plurality of supported channel BWs may include any other additional or alternative channel BWs.

In some demonstrative aspects, controller 154 may be configured to control, trigger, cause, and/or instruct the STA implemented by device 140 to determine the usage-based channel BW setting based, for example, on a power consumption of a radio of the STA, for example, to communicate over the wireless communication link according to the operating channel BW setting for the STA, e.g., as described below.

In some demonstrative aspects, controller 154 may be configured to control, trigger, cause, and/or instruct the STA implemented by device 140 to determine the usage-based channel BW setting to result, for example, in a first power consumption level of the radio of the STA for communication of the traffic, e.g., as described below.

In some demonstrative aspects, controller 154 may be configured to control, trigger, cause, and/or instruct the STA implemented by device 140 to determine the usage-based channel BW setting, for example, such the first power consumption level is lower than a second power consumption level of the radio of STA for communication of the traffic over the available channel BW of the STA, e.g., as described below.

In some demonstrative aspects, controller 154 may be configured to control, trigger, cause, and/or instruct the STA implemented by device 140 to determine the usage-based channel BW setting to include, for example, a lowest supported channel BW, which is supported by the STA, and which complies with a condition corresponding to the link-usage parameter, e.g., as described below.

In some demonstrative aspects, controller 154 may be configured to control, trigger, cause, and/or instruct the STA implemented by device 140 to monitor the link-usage parameter, and to update the usage-based channel BW setting based, for example, on a change in the link-usage parameter, e.g., as described below.

In some demonstrative aspects, controller 154 may be configured to control, trigger, cause, and/or instruct the STA implemented by device 140 to determine the usage-based channel BW setting based on the link-usage parameter, which may be based, for example, on an activity of a radio of the STA to communicate over the wireless communication link, for example, according to the operating channel BW setting for the STA, e.g., as described below.

In some demonstrative aspects, controller 154 may be configured to control, trigger, cause, and/or instruct the STA implemented by device 140 to determine the usage-based channel BW setting based on the link-usage parameter, which may be based, for example, on a Transmit (Tx) activity of the STA to transmit uplink traffic over the wireless communication link, for example, according to the operating channel BW setting for the STA, e.g., as described below.

In some demonstrative aspects, controller 154 may be configured to control, trigger, cause, and/or instruct the STA implemented by device 140 to determine the usage-based channel BW setting based on the link-usage parameter, which may be based, for example, on a Receive (Rx) activity of the STA to receive downlink traffic over the wireless communication link, for example, according to the operating channel BW setting for the STA, e.g., as described below.

In some demonstrative aspects, controller 154 may be configured to control, trigger, cause, and/or instruct the STA implemented by device 140 to determine the usage-based channel BW setting based on the link-usage parameter, which may be based, for example, on a Tx time percentage of the STA, e.g., as described below.

In some demonstrative aspects, the Tx time percentage of the STA may include, or may be based on, for example, a percentage of time used by the STA to transmit uplink traffic over the wireless communication link according to the operating channel BW setting for the STA, e.g., as described below.

In some demonstrative aspects, controller 154 may be configured to control, trigger, cause, and/or instruct the STA implemented by device 140 to determine the usage-based channel BW setting based on the link-usage parameter, which may be based, for example, on an Rx time percentage of the STA, e.g., as described below.

In some demonstrative aspects, the Rx time percentage of the STA may include, or may be based on, for example, a percentage of time used by the STA to receive downlink traffic over the wireless communication link according to the operating channel BW setting for the STA, e.g., as described below.

In some demonstrative aspects, controller 154 may be configured to control, trigger, cause, and/or instruct the STA implemented by device 140 to determine the usage-based channel BW setting based on the link-usage parameter, which may be based, for example, on a sum of the Tx time percentage of the STA and the Rx time percentage of the STA.

In some demonstrative aspects, controller 154 may be configured to control, trigger, cause, and/or instruct the STA implemented by device 140 to determine the usage-based channel BW setting based on the link-usage parameter, which may be based, for example, on a link-usage time percentage of the STA, e.g., as described below.

In some demonstrative aspects, the link-usage time percentage of the STA may include, or may be based on, for example, a total percentage of time used by the STA to transmit uplink traffic over the wireless communication link according to the operating channel BW setting for the STA or to receive downlink traffic over the wireless communication link according to the operating channel BW setting for the STA, e.g., as described below.

In some demonstrative aspects, controller 154 may be configured to control, trigger, cause, and/or instruct the STA implemented by device 140 to determine the usage-based channel BW setting based on the link-usage parameter, which may be based, for example, on a non-link-usage time percentage of the STA, e.g., as described below.

In some demonstrative aspects, the non-link-usage time percentage of the STA may include, or may be based on, for example, a percentage of time during which the STA is to listen over the wireless communication link according to the operating channel BW setting for the STA while no transmission or reception of the traffic is performed.

In some demonstrative aspects, controller 154 may determine a Tx time percentage and an Rx time percentage of the STA implemented by device 140 over an operating channel BW setting of the STA.

In one example, controller 154 may determine the Tx time percentage of 2% and the Rx time percentage of 3% over an operating channel BW setting of 160 MHz.

In some demonstrative aspects, controller 154 may determine a link-usage time percentage of the STA, for example, based on a sum of the Tx time percentage and an Rx time percentage of the STA implemented by device 140 over an operating channel BW setting of the STA.

In one example, controller 154 may determine the link-usage time percentage of the STA for the operating channel BW setting of 160 MHz to be 5%, for example, based on the sum of the Tx time percentage of 2% and the Rx time percentage of 3%.

In some demonstrative aspects, controller 154 may determine whether a narrower channel BW setting may be used for the STA, for example, based on the link-usage time percentage of the STA.

For example, it may be assumed that, for example, when reducing the channel BW setting of the STA by a factor of X, then, for example, in a worst case scenario, a Tx duration and/or an Rx duration may be increased by about the factor of X.

For example, controller 154 determine that reducing the channel BW setting of the STA from 160 MHz to 80 Mhz may result in multiplying the link-usage time percentage of the STA, e.g., by a factor of about 2, for example, up to about 2*5%=10%.

For example, controller 154 determine that reducing the channel BW setting of the STA from 160 MHz to 40 Mhz may result in multiplying the link-usage time percentage of the STA, e.g., by a factor of about 4, for example, up to about 4*5%=20%.

For example, controller 154 determine that reducing the channel BW setting of the STA from 160 MHz to 20 Mhz may result in multiplying the link-usage time percentage of the STA, e.g., by a factor of about 8, for example, up to about 8*5%=40%.

In some demonstrative aspects, controller 154 may determine the usage-based channel BW setting for the STA, for example, based on the estimated link-usage time percentage of the STA corresponding to the reduced channel BWs of 80 Mhz, 40 MHz and/or 20 Mhz.

In some demonstrative aspects, controller 154 may be configured to control, trigger, cause, and/or instruct the STA implemented by device 140 to determine the usage-based channel BW setting based on the link-usage parameter, which may be based, for example, on a Throughput (TPT) requirement corresponding to the traffic to be communicated between the STA and the AP over the wireless communication link, e.g., as described below.

In some demonstrative aspects, the TPT requirement may be based, for example, on an uplink TPT requirement for communication of uplink transmissions from the STA to the AP, e.g., as described below.

In some demonstrative aspects, the TPT requirement may be based, for example, on a downlink TPT requirement for communication of downlink transmissions from the AP to the STA, e.g., as described below.

In some demonstrative aspects, controller 154 may be configured to control, trigger, cause, and/or instruct the STA implemented by device 140 to determine the TPT requirement, for example, based on a measured throughput of the traffic communicated between the STA and the AP over the wireless communication link, e.g., as described below.

In some demonstrative aspects, controller 154 may be configured to control, trigger, cause, and/or instruct the STA implemented by device 140 to identify the TPT requirement based, for example, on TPT-requirement information from an application to process the traffic communicated by the STA, e.g., as described below.

In other aspects, controller 154 may be configured to control, trigger, cause, and/or instruct the STA implemented by device 140 to determine the TPT requirement based on any other additional or alternative information and/or indication.

In some demonstrative aspects, controller 154 may be configured to control, trigger, cause, and/or instruct the STA implemented by device 140 to determine the usage-based channel BW setting for the STA, for example, based on a type of the traffic to be communicated by the STA, e.g., as described below.

In some demonstrative aspects, controller 154 may be configured to control, trigger, cause, and/or instruct the STA implemented by device 140 to determine the usage-based channel BW setting for the STA, for example, based on a type of an application to process the traffic to be communicated by the STA, e.g., as described below.

In other aspects, controller 154 may be configured to control, trigger, cause, and/or instruct the STA implemented by device 140 to determine the usage-based channel BW setting for the STA based on any other additional or alternative suitable parameters and/or criteria.

In some demonstrative aspects, a STA, e.g., as STA implemented by device 102, a STA implemented by device 140, and/or a STA implemented by device 160, may be configured to determine a selected operating channel, for example, based on a target TPT, e.g., as described below.

In some demonstrative aspects, the STA may be configured to select the operating channel width to include a channel width, which is substantially always equal to or higher than, e.g., slightly higher than, the target TPT.

In some demonstrative aspects, the STA may be configured to determine the target TPT, for example, based on application information indicating one or more requirements of an application for which traffic is to be communicated by the STA, e.g., as described below.

For example, the application information may be received from a Network (NW) stack of an Operating System (OS), a driver, an application layer, or the like.

In some demonstrative aspects, the STA may be configured to determine the target TPT, for example, based on Quality of Service (QOS) information indicating one or more required QoS characteristics for the traffic to be communicated by the STA.

In some demonstrative aspects, the STA may be configured to determine the target TPT, for example, based on an actual achieved TPT, e.g., actual transmit TPT and/or actual receive TPT.

For example, the STA may be configured to measure the actual achieved TPT, e.g., in RX/TX, and to dynamically set the target TPT, for example, at a predefined margin below the actual TPT.

For example, the STA may be configured to set the selected operating channel BW, for example, to keep a predefined margin, e.g., a predefined % margin, below a maximal possible TPT, e.g., per the selected operating channel BW.

In some demonstrative aspects, controller 154 may be configured to control, trigger, cause, and/or instruct the STA implemented by device 140 according to a channel BW configuration mechanism, which may be may be configured to select, e.g., to dynamically select, the operating channel width for the STA, for example, such that the STA may operate at the lowest channel width, which still meets requirements of receive and/or transmit activities of the STA, e.g., as described below.

In some demonstrative aspects, the channel BW configuration mechanism may be configured to provide a technical solution to support reduced, e.g., optimized, power consumption of the STA, for example, while meeting requirements of the required receive and/or transmit activities of the STA, e.g., as described below.

In some demonstrative aspects, controller 154 may be configured to control, trigger, cause, and/or instruct the STA implemented by device 140 to determine a selected operating channel, for example, based on detection (measurement), e.g., real time detection, of actual receive and/or transmit requirements of traffic being communicated by the STA.

For example, controller 154 may be configured to control, trigger, cause, and/or instruct the STA implemented by device 140 to monitor the actual receive and/or transmit activities, and may select an operating channel width based on the actual determined, e.g., measured, receive and/or transmit activities.

In one example, controller 154 may be configured to control, trigger, cause, and/or instruct the STA implemented by device 140 to select the operating channel width to include a channel width, which is substantially always equal to or higher than, e.g., slightly higher than, an actual required channel BW based on the actual Tx and/or Rx activities of the STA.

In some demonstrative aspects, a wireless communication device, e.g., device 102, device 140, and/or device 160, may be configured to determine a selected operating channel, for example, based on application-based information corresponding to an application for which traffic is to be communicated by the wireless communication device.

In some demonstrative aspects, the application-based information corresponding to the application may include, for example, an indication of a required throughput for the application, and/or any other additional or alternative information relating to one or more requirements of the application, and/or characteristics of the traffic to be communicated for the application.

For example, a wireless communication driver, e.g., a Wi-Fi driver, of the wireless communication device may be configured to obtain the application-based information from an application layer of the application.

In one example, the Wi-Fi driver may be configured to obtain an indication of an overall required throughput for an ongoing use case, e.g., from the application layer, a connection manager, a connection and traffic prioritization manager, and/or any other element, of an application, e.g., an online meeting application, a video streaming application, or the like. For example, the Wi-Fi driver may be configured to select an operating channel width that can support the required throughput.

In some demonstrative aspects, a wireless communication device, e.g., device 102, device 140, and/or device 160, may include an MLD. For example, the MLD may be configured to perform BW adaptation, for example, per some or all links the MLD operates on.

In one example, the MLD may monitor the Rx and/or Tx activities across multiple links. For example, the MLD may configure an operating channel BW, e.g., an optimized operating BW, per link, for example, based on the Rx and/or Tx activities over the link.

In another example, the MLD may estimate the overall TPT across multiple links. For example, the MLD may configure an operating channel BW, e.g., an optimized operating BW, per link, for example, based on the overall TPT.

For example, the MLD may configure an operating channel BW for a particular link, e.g., separately and/or independently, form other links.

For example, MLD may configure a first operating channel BW for a first link/channel, and a second operating channel BW, e.g., different from the first operating channel BW, for a second link/channel.

In some demonstrative aspects, controller 154 may be configured to control, trigger, cause, and/or instruct the STA implemented by device 140 to determine the usage-based channel BW setting for the STA based, for example, on an available capacity of a Basic Service Set (BSS) of the AP, e.g., as described below.

In some demonstrative aspects, controller 154 may be configured to control, trigger, cause, and/or instruct the STA implemented by device 140 to determine the usage-based channel BW setting based, for example, on a condition that the available capacity of the BSS of the AP is to be maintained above a BSS capacity threshold, e.g., as described below.

In some demonstrative aspects, controller 154 may be configured to control, trigger, cause, and/or instruct the STA implemented by device 140 to identify the available capacity of the BSS of the AP based, for example, on a BSS load element, for example, in a beacon from the AP, e.g., as described below.

In some demonstrative aspects, controller 154 may be configured to control, trigger, cause, and/or instruct the STA implemented by device 140 to estimate the available capacity of the BSS of the AP based, for example, on a detected amount of traffic communicated between the AP and one or more other STAs in the BSS of the AP, e.g., as described below.

In other aspects, controller 154 may be configured to control, trigger, cause, and/or instruct the STA implemented by device 140 to determine and/or identify the available capacity of the BSS of the AP based on any other additional or alternative information and/or criteria.

In some demonstrative aspects, controller 154 may be configured to control, trigger, cause, and/or instruct the STA implemented by device 140 to determine the usage-based channel BW setting for the STA to include, for example, a lowest supported channel BW, which is supported by the STA, and which complies with a condition corresponding to the link-usage parameter and the available capacity of the BSS, e.g., as described below.

In some demonstrative aspects, for example, in some use cases and/or scenarios, an overall available BSS capacity may be reduced, for example, when operating a STA of the BSS in a lower channel width. For example, a time required to transmit a given payload over the air may be longer, e.g., as the transmission channel width is lower.

In some demonstrative aspects, controller 154 may be configured to control, trigger, cause, and/or instruct the STA implemented by device 140 to determine the channel BW setting for the STA, for example, based on a criterion corresponding to an overall BSS throughput performance of a BSS to which the STA belongs, for example, a BSS of the AP implemented by device 102, e.g., as described below.

In some demonstrative aspects, controller 154 may be configured to control, trigger, cause, and/or instruct the STA implemented by device 140 to select the channel BW setting for the STA, for example, based on a criterion corresponding to an actual BSS load of the BSS, e.g., as described below.

In some demonstrative aspects, the criterion corresponding to the actual BSS load of the BSS may be configured, for example, to provide a technical solution to avoid cases where the selected channel BW setting for the STA may be too low, e.g., in order to avoid a situation where the selected channel BW setting for the STA may harm an overall Wi-Fi experience on the BSS.

In some demonstrative aspects, controller 154 may be configured to control, trigger, cause, and/or instruct the STA implemented by device 140 to monitor the actual BSS load of the BSS to which the STA belongs, e.g., as described below.

In some demonstrative aspects, controller 154 may be configured to control, trigger, cause, and/or instruct the STA implemented by device 140 to select the channel BW setting for the STA, for example, while avoiding lowering the operating channel width too much, e.g., beyond a level that will have negative impact on the overall BSS throughput performance.

In some demonstrative aspects, controller 154 may be configured to control, trigger, cause, and/or instruct the STA implemented by device 140 to determine a BSS load estimation of the actual BSS load and/or a BSS capacity estimation of the actual BSS capacity, for example, based on a BSS load element, which may be received from an AP of the BSS, e.g., the AP implemented by device 102.

In one example, controller 154 may be configured to control, trigger, cause, and/or instruct the STA implemented by device 140 to process a beacon from the AP, for example, to identify a BSS load element, which may include information on a current STA population and/or traffic levels in the BSS.

For example, controller 154 may be configured to control, trigger, cause, and/or instruct the STA implemented by device 140 to identify a count of STAs in the BSS, e.g., based on a STA count field in the BSS load element, a channel utilization level of the BSS, e.g., based on a channel utilization field in the BSS load element, and/or an available capacity of the BSS, e.g., based on an available admission capacity field in the BSS load element.

In some demonstrative aspects, controller 154 may be configured to control, trigger, cause, and/or instruct the STA implemented by device 140 to determine the BSS load estimation of the actual BSS load and/or the BSS capacity estimation of the actual BSS capacity, for example, while taking into account advertised information from the AP of the BSS, e.g., the AP implemented by device 102.

For example, advertised information, e.g., advertised AP capabilities information, from the AP may include throughput capacity information, BW information, Number of Spatial Streams (NSS) information, Modulation and Coding Scheme (MCS) information, or the like.

In some demonstrative aspects, controller 154 may be configured to control, trigger, cause, and/or instruct the STA implemented by device 140 to determine the BSS load estimation of the actual BSS load and/or the BSS capacity estimation of the actual BSS capacity, for example, based on a detected number of different MAC addresses using the same BSS Identifier (BSSID) as the BSSID of the BSS of the STA. For example, the number of different MAC addresses may be detected by an air sniffing functionality of the STA.

In some demonstrative aspects, controller 154 may be configured to control, trigger, cause, and/or instruct the STA implemented by device 140 to determine the BSS load estimation of the actual BSS load and/or the BSS capacity estimation of the actual BSS capacity, for example, based on a calculation, e.g., in a medium access function, of a percentage of time that the wireless communication medium (air) is busy by communications of other STAs in the BSS.

In some demonstrative aspects, controller 154 may be configured to control, trigger, cause, and/or instruct the STA implemented by device 140 to determine the BSS load estimation of the actual BSS load and/or the BSS capacity estimation of the actual BSS capacity, for example, based on a backoff timer countdown behavior of the STA, e.g., based on Enhanced Distributed Channel Access (EDCA) backoff counters of the STA.

In other aspects, controller 154 may be configured to control, trigger, cause, and/or instruct the STA implemented by device 140 to determine a BSS load estimation of the actual BSS load, for example, based on any other additional or alternative information.

In some demonstrative aspects, controller 154 may be configured to control, trigger, cause, and/or instruct the STA implemented by device 140 to select the channel BW setting for the STA, for example, while avoiding an overloading of the BSS, for example, by maintaining the BSS load below a predefined load threshold level, e.g., below about 60%, or any other level.

In one example, the BSS load threshold level may be configured as a BSS load level of 60%, for example, in accordance with an enterprise BSS load target level. In other aspects, any other BBS load threshold level may be implemented.

In some demonstrative aspects, configuring the STA to select the channel BW setting for the STA, for example, while maintaining the BSS load below the predefined load threshold level may provide a technical solution to avoid substantial harm to the performance of the network (NW), the BSS, and/or other STAs in the BSS.

In some demonstrative aspects, controller 154 may be configured to control, trigger, cause, and/or instruct the STA implemented by device 140 to identify whether reducing the channel BW setting for the STA, e.g., for power saving, may result in a situation where one or more requirements for communicating the traffic of the STA, e.g., as mat be set by an application, e.g., a throughput requirement, a QoS requirement, and/or a latency requirement, may not be met, and/or a situation where an internal TPT margin target of the STA may not be met.

In some demonstrative aspects, controller 154 may be configured to control, trigger, cause, and/or instruct the STA implemented by device 140 to raise the channel BW setting for the STA, for example, to a channel BW setting which may support the traffic requirements for the STA, e.g., traffic requirements of the application, and/or a level which may meet the internal TPT margin target of the STA.

In some demonstrative aspects, controller 154 may be configured to control, trigger, cause, and/or instruct the STA implemented by device 140 to determine the selected channel BW setting for the STA, for example, based on combination of the traffic requirements for the STA, e.g., Rx requirements, Tx requirements, and/or TPT requirements, and the impact on the BSS to which the STA belongs, e.g., as described above.

In some demonstrative aspects, controller 154 may be configured to control, trigger, cause, and/or instruct the STA implemented by device 140 to transmit to the AP implemented by device 102 a channel width indication to indicate a request for a channel width to be used for communication between the STA and the AP.

In some demonstrative aspects, controller 154 may be configured to control, trigger, cause, and/or instruct the STA implemented by device 140 to transmit to the AP a channel width indication to indicate a request that the AP use the selected channel BW setting, which is selected by the STA, for communication with the STA.

In some demonstrative aspects, controller 154 may be configured to control, trigger, cause, and/or instruct the STA implemented by device 140 to transmit the channel width indication, for example, in an Operation Mode Indication (OMI).

For example, controller 154 may be configured to control, trigger, cause, and/or instruct the STA implemented by device 140 to transmit to the AP an OMI, which may include an OM control field including a control information subfield.

For example, controller 154 may be configured to control, trigger, cause, and/or instruct the STA implemented by device 140 to set a channel width subfield in the control information subfield to indicate a required channel width to be used by the AP for communicating with the STA.

For example, controller 154 may be configured to control, trigger, cause, and/or instruct the STA implemented by device 140 to configure the channel width subfield to include the selected operating channel width which is selected by the STA, e.g., based on the link-usage parameter.

In some demonstrative aspects, controller 154 may be configured to control, trigger, cause, and/or instruct the STA implemented by device 140 to utilize the channel width subfield, for example, to dynamically request the AP to change the channel width the AP uses when transmitting to the STA and/or when triggering an Uplink (UL) transmission from the STA, e.g., as part of an UL OFDMA transmission, for example, based on the selected operating channel width which is selected by the STA, e.g., based on the link-usage parameter.

In some demonstrative aspects, controller 154 may be configured to control, trigger, cause, and/or instruct the STA implemented by device 140 to utilize the channel width subfield, for example, to change the channel width the AP uses when transmitting to the STA, for example, such that the STA may still be allowed to participate in Multi User (MU) transmissions which may be sent in a wider channel width than the operating channel width of the STA.

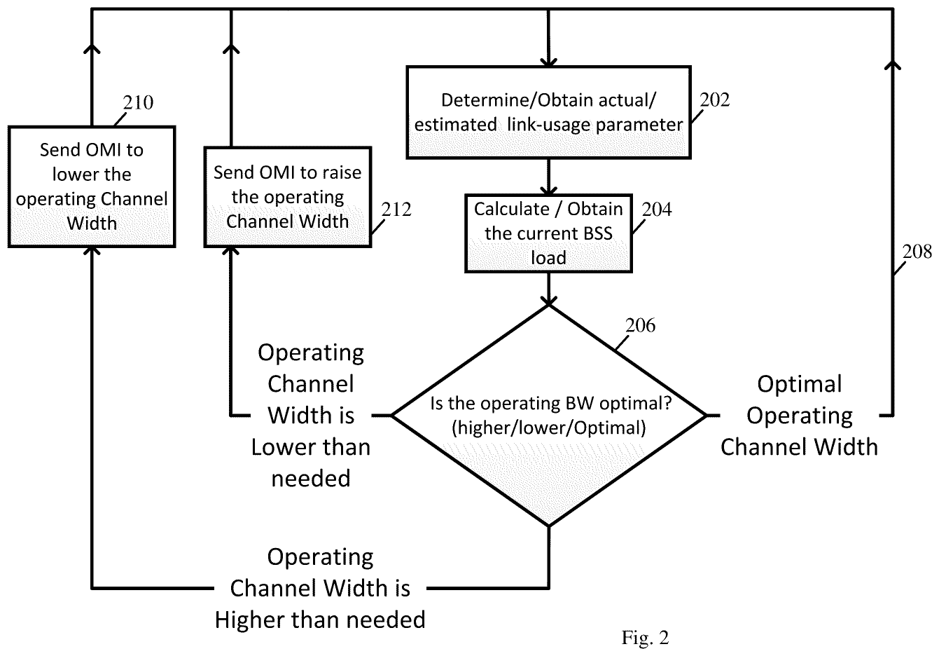

Reference is made to FIG. 2, which schematically illustrates a method of configuring a channel bandwidth for wireless communication, in accordance with some demonstrative aspects. For example, one or more of the operations of the method of FIG. 2 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

In some demonstrative aspects, as indicated at block 202, the method may include monitoring at a STA a link usage parameter, for example, an actual and/or estimated link-usage parameter, corresponding to a usage of a wireless communication link for communication of traffic between the STA and an AP. For example, controller 154 (FIG. 1) may be configured to control, trigger, cause, and/or instruct the STA implemented by device 140 (FIG. 1) to determine and/or obtain the actual and/or estimated link-usage parameter, e.g., as described above.

In some demonstrative aspects, as indicated at block 204, the method may include identifying a current BSS load of a BSS including the wireless communication link of the STA. For example, controller 154 (FIG. 1) may be configured to control, trigger, cause, and/or instruct the STA implemented by device 140 (FIG. 1) to estimate and/or obtain the current BSS load of the BSS of the AP implemented by device 102 (FIG. 1), e.g., as described above.

In some demonstrative aspects, as indicated at block 206, the method may include determining whether or not the operating channel BW setting for the STA is optimal. For example, determining whether or not the operating channel BW setting for the STA is optimal may include determining whether a usage-based channel BW setting, e.g., based on the link-usage parameter, is lower than, equal to, or higher than the operating channel BW setting for the STA, e.g., as described above. For example, determining whether or not the operating channel BW setting for the STA is optimal may include determining whether the operating channel BW setting for the STA may be changed, for example, while complying with a BSS requirement according to the current BSS load, e.g., as described above. For example, controller 154 (FIG. 1) may be configured to control, trigger, cause, and/or instruct the STA implemented by device 140 (FIG. 1) to determine whether or not the operating channel BW setting for the STA is to be adjusted, for example, based on the usage-based channel BW setting for the STA, which may be based on the link-usage parameter, e.g., as described above.

In some demonstrative aspects, as indicated at arrow 208, the method may include maintaining the operating channel BW setting for the STA, for example, based on a determination that the operating channel BW setting for the STA is optimal. For example, controller 154 (FIG. 1) may be configured to control, trigger, cause, and/or instruct the STA implemented by device 140 (FIG. 1) to maintain the operating channel BW setting for the STA and to continue monitoring the link usage parameter for a change.

In some demonstrative aspects, as indicated at arrow 210, the method may include transmitting to the AP a channel BW reduction request, e.g., as part of an OMI, to reduce the operating channel width setting for the STA, for example, based on a determination that the operating channel BW setting for the STA should be reduced. For example, controller 154 (FIG. 1) may be configured to control, trigger, cause, and/or instruct the STA implemented by device 140 to transmit the channel BW reduction request to the AP implemented by device 102 (FIG. 1), e.g., as described above.

In some demonstrative aspects, as indicated at arrow 212, the method may include transmitting to the AP a channel BW increase request, e.g., as part of an OMI, to increase the operating channel width setting for the STA, for example, based on a determination that the operating channel BW setting for the STA should be increased. For example, controller 154 (FIG. 1) may be configured to control, trigger, cause, and/or instruct the STA implemented by device 140 to transmit the channel BW increase request to the AP implemented by device 102 (FIG. 1), e.g., as described above.

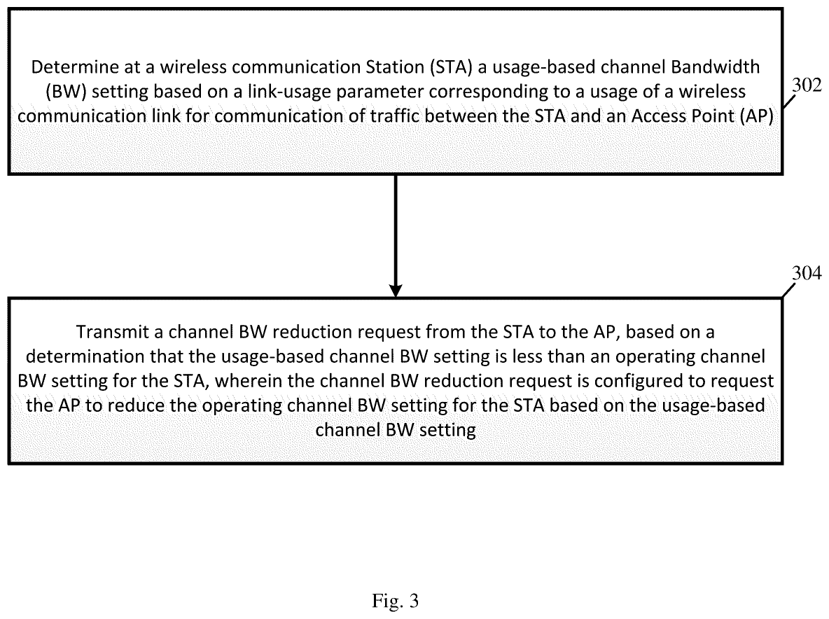

Reference is made to FIG. 3, which schematically illustrates a method of configuring a channel bandwidth for wireless communication, in accordance with some demonstrative aspects. For example, one or more of the operations of the method of FIG. 3 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

In some demonstrative aspects, as indicated at block 302, the method may include determining at a STA a usage-based channel BW setting based on a link-usage parameter corresponding to a usage of a wireless communication link for communication of traffic between the STA and an AP. For example, controller 154 (FIG. 1) may be configured to control, trigger, cause, and/or instruct the STA implemented by device 140 (FIG. 1) to determine the usage-based channel BW setting for the STA, for example, based on a link-usage parameter corresponding to a usage of a wireless communication link for communication of traffic between the STA and an AP implemented by device 102 (FIG. 1), e.g., as described above.

In some demonstrative aspects, as indicated at block 304, the method may include transmitting a channel BW reduction request from the STA to the AP, for example, based on a determination that the usage-based channel BW setting is less than an operating channel BW setting for the STA. For example, the channel BW reduction request may be configured to request the AP to reduce the operating channel BW setting for the STA, e.g., based on the usage-based channel BW setting. For example, controller 154 (FIG. 1) may be configured to control, trigger, cause, and/or instruct the STA implemented by device 140 (FIG. 1) to transmit the channel BW reduction request to the AP implemented by device 102 (FIG. 1), for example, based on a determination that the usage-based channel BW setting is less than the operating channel BW setting for the STA, e.g., as described above.

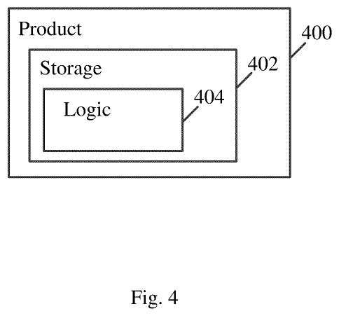

Reference is made to FIG. 4, which schematically illustrates a product of manufacture 400, in accordance with some demonstrative aspects. Product 400 may include one or more tangible computer-readable (“machine-readable”) non-transitory storage media 402, which may include computer-executable instructions, e.g., implemented by logic 404, operable to, when executed by at least one computer processor, enable the at least one computer processor to implement one or more operations at device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1); to cause device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1) to perform, trigger and/or implement one or more operations and/or functionalities; and/or to perform, trigger and/or implement one or more operations and/or functionalities described with reference to the FIGS. 1-3, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 400 and/or machine readable storage media 402 may include one or more types of computer-readable storage media capable of storing data, including volatile memory, non-volatile memory, removable or non-removable memory, erasable or non-erasable memory, writeable or re-writeable memory, and the like. For example, machine readable storage media 402 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 404 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 404 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### Examples

The following examples pertain to further aspects.

Example 1 includes an apparatus comprising logic and circuitry configured to cause a wireless communication Station (STA) to determine a usage-based channel Bandwidth (BW) setting based on a link-usage parameter corresponding to a usage of a wireless communication link for communication of traffic between the STA and an Access Point (AP); and transmit a channel BW reduction request to the AP based on a determination that the usage-based channel BW setting is less than an operating channel BW setting for the STA, wherein the channel BW reduction request is configured to request the AP to reduce the operating channel BW setting for the STA based on the usage-based channel BW setting.

Example 2 includes the subject matter of Example 1, and optionally, wherein the link-usage parameter is based on an activity of a radio of the STA to communicate over the wireless communication link according to the operating channel BW setting for the STA.

Example 3 includes the subject matter of Example 1 or 2, and optionally, wherein the link-usage parameter is based on at least one of a Transmit (Tx) activity of the STA to transmit uplink traffic over the wireless communication link according to the operating channel BW setting for the STA, or a Receive (Rx) activity of the STA to receive downlink traffic over the wireless communication link according to the operating channel BW setting for the STA.

Example 4 includes the subject matter of any one of Examples 1-3, and optionally, wherein the link-usage parameter is based on at least one of a Transmit (Tx) time percentage of the STA or a Receive (Rx) time percentage of the STA, wherein the Tx time percentage of the STA comprises a percentage of time used by the STA to transmit uplink traffic over the wireless communication link according to the operating channel BW setting for the STA, wherein the Rx time percentage of the STA comprises a percentage of time used by the STA to receive downlink traffic over the wireless communication link according to the operating channel BW setting for the STA.

Example 5 includes the subject matter of Example 4, and optionally, wherein the link-usage parameter is based on a sum of the Tx time percentage of the STA and the Rx time percentage of the STA.

Example 6 includes the subject matter of any one of Examples 1-5, and optionally, wherein the link-usage parameter is based on a link-usage time percentage of the STA, wherein the link-usage time percentage of the STA comprises a total percentage of time used by the STA to transmit uplink traffic over the wireless communication link according to the operating channel BW setting for the STA or to receive downlink traffic over the wireless communication link according to the operating channel BW setting for the STA.

Example 7 includes the subject matter of any one of Examples 1-6, and optionally, wherein the link-usage parameter is based on a non-link-usage time percentage of the STA, the non-link-usage time percentage of the STA comprising a percentage of time during which the STA is to listen over the wireless communication link according to the operating channel BW setting for the STA while no transmission or reception of the traffic is performed.

Example 8 includes the subject matter of any one of Examples 1-7, and optionally, wherein the link-usage parameter is based on a Throughput (TPT) requirement corresponding to the traffic to be communicated between the STA and the AP over the wireless communication link.

Example 9 includes the subject matter of Example 8, and optionally, wherein the TPT requirement is based on at least one of an uplink TPT requirement for communication of uplink transmissions from the STA to the AP, or a downlink TPT requirement for communication of downlink transmissions from the AP to the STA.

Example 10 includes the subject matter of any one of Examples 8 or 9, and optionally, wherein the apparatus is configured to cause the STA to determine the TPT requirement based on a measured throughput of the traffic communicated between the STA and the AP over the wireless communication link.

Example 11 includes the subject matter of any one of Examples 8-10, and optionally, wherein the apparatus is configured to cause the STA to identify the TPT requirement based on TPT-requirement information from an application to process the traffic.

Example 12 includes the subject matter of any one of Examples 1-11, and optionally, wherein the apparatus is configured to cause the STA to determine the usage-based channel BW setting based on an available capacity of a Basic Service Set (BSS) of the AP.

Example 13 includes the subject matter of Example 12, and optionally, wherein the apparatus is configured to cause the STA to determine the usage-based channel BW setting based on a condition that the available capacity of the BSS of the AP is to be maintained above a BSS capacity threshold.

Example 14 includes the subject matter of Example 13, and optionally, wherein the apparatus is configured to cause the STA to identify the available capacity of the BSS of the AP based on a BSS load element in a beacon from the AP.

Example 15 includes the subject matter of Example 13 or 14, and optionally, wherein the apparatus is configured to cause the STA to estimate the available capacity of the BSS of the AP based on a detected amount of traffic communicated between the AP and one or more other STAs in the BSS of the AP.

Example 16 includes the subject matter of any one of Examples 12-15, and optionally, wherein the apparatus is configured to cause the STA to determine the usage-based channel BW setting comprising a lowest supported channel BW, which is supported by the STA, and which complies with a condition corresponding to the link-usage parameter and the available capacity of the BSS.

Example 17 includes the subject matter of any one of Examples 1-16, and optionally, wherein the apparatus is configured to cause the STA to determine the usage-based channel BW setting based on a power consumption of a radio of the STA to communicate over the wireless communication link according to the operating channel BW setting for the STA.

Example 18 includes the subject matter of any one of Examples 1-17, and optionally, wherein the apparatus is configured to cause the STA to determine the usage-based channel BW setting to result in a first power consumption level of a radio of the STA for communication of the traffic, wherein the first power consumption level is lower than a second power consumption level of the radio of STA for communication of the traffic over the available channel BW of the STA.

Example 19 includes the subject matter of cany one of Examples 1-18, and optionally, wherein the apparatus is configured to cause the STA to select the usage-based channel BW setting from a plurality of supported channel BWs, which are supported by the STA, based on the link-usage parameter.

Example 20 includes the subject matter of Example 19, and optionally, wherein the plurality of supported channel BWs comprises one or more channel BWs of a 20 Megahertz (MHz) channel BW, a 40 MHz channel BW, an 80 MHz channel BW, a 160 MHz channel BW, or a 320 MHz channel BW.

Example 21 includes the subject matter of any one of Examples 1-20, and optionally, wherein the apparatus is configured to cause the STA to set the channel BW reduction request by setting a channel width subfield based on the usage-based channel BW setting, and setting the channel width subfield in an Operating mode (OM) control subfield to be transmitted from the STA to the AP.

Example 22 includes the subject matter of any one of Examples 1-21, and optionally, wherein the apparatus is configured to cause the STA to determine the usage-based channel BW setting comprising a lowest supported channel BW, which is supported by the STA, and which complies with a condition corresponding to the link-usage parameter.

Example 23 includes the subject matter of any one of Examples 1-22, and optionally, wherein the apparatus is configured to cause the STA to monitor the link-usage parameter, and to update the usage-based channel BW setting based on a change in the link-usage parameter.

Example 24 includes the subject matter of any one of Examples 1-23, and optionally, wherein the apparatus is configured to cause the STA to transmit a channel BW increase request to the AP based on a determination that the usage-based channel BW setting is greater than the operating channel BW setting for the STA, wherein the channel BW increase request is configured to request the AP to increase the operating channel BW setting for the STA based on the usage-based channel BW setting.

Example 25 includes the subject matter of any one of Examples 1-24, and optionally, wherein the apparatus is configured to cause the STA to determine the usage-based channel BW setting based on a type of the traffic.

Example 26 includes the subject matter of any one of Examples 1-25, and optionally, wherein the apparatus is configured to cause the STA to determine the usage-based channel BW setting based on a type of an application to process the traffic.

Example 27 includes the subject matter of any one of Examples 1-26, and optionally, wherein the operating channel BW setting of the STA comprises an AP-assigned setting of the channel BW, which is assigned by the AP to the STA.

Example 28 includes the subject matter of any one of Examples 1-27, and optionally, comprising a radio to communicate the traffic over the wireless communication link.

Example 29 includes the subject matter of Example 28, and optionally, comprising one or more antennas connected to the radio, and a processor to execute instructions of an operating system of the STA.

Example 30 comprises a wireless communication device comprising the apparatus of any of Examples 1-29.

Example 31 comprises a mobile device comprising the apparatus of any of Examples 1-29.

Example 32 comprises an apparatus comprising means for executing any of the described operations of any of Examples 1-29.

Example 33 comprises a product comprising one or more tangible computer-readable non-transitory storage media comprising instructions operable to, when executed by at least one processor, enable the at least one processor to cause a wireless communication device to perform any of the described operations of any of Examples 1-29.

Example 34 comprises an apparatus comprising: a memory interface; and processing circuitry configured to: perform any of the described operations of any of Examples 1-29.

Example 35 comprises a method comprising any of the described operations of any of Examples 1-29.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising logic and circuitry configured to cause a wireless communication Station (STA) to:
determine a usage-based channel Bandwidth (BW) setting based on a link-usage parameter corresponding to a usage of a wireless communication link for communication of traffic between the STA and an Access Point (AP); and
transmit a channel BW reduction request to the AP based on a determination that the usage-based channel BW setting is less than an operating channel BW setting for the STA, wherein the channel BW reduction request is configured to request the AP to reduce the operating channel BW setting for the STA based on the usage-based channel BW setting.

2. The apparatus of claim 1, wherein the link-usage parameter is based on an activity of a radio of the STA to communicate over the wireless communication link according to the operating channel BW setting for the STA.

3. The apparatus of claim 1, wherein the link-usage parameter is based on at least one of a Transmit (Tx) activity of the STA to transmit uplink traffic over the wireless communication link according to the operating channel BW setting for the STA, or a Receive (Rx) activity of the STA to receive downlink traffic over the wireless communication link according to the operating channel BW setting for the STA.

4. The apparatus of claim 1, wherein the link-usage parameter is based on at least one of a Transmit (Tx) time percentage of the STA or a Receive (Rx) time percentage of the STA, wherein the Tx time percentage of the STA comprises a percentage of time used by the STA to transmit uplink traffic over the wireless communication link according to the operating channel BW setting for the STA, wherein the Rx time percentage of the STA comprises a percentage of time used by the STA to receive downlink traffic over the wireless communication link according to the operating channel BW setting for the STA.

5. The apparatus of claim 4, wherein the link-usage parameter is based on a sum of the Tx time percentage of the STA and the Rx time percentage of the STA.

6. The apparatus of claim 1, wherein the link-usage parameter is based on a link-usage time percentage of the STA, wherein the link-usage time percentage of the STA comprises a total percentage of time used by the STA to transmit uplink traffic over the wireless communication link according to the operating channel BW setting for the STA or to receive downlink traffic over the wireless communication link according to the operating channel BW setting for the STA.

7. The apparatus of claim 1, wherein the link-usage parameter is based on a non-link-usage time percentage of the STA, the non-link-usage time percentage of the STA comprising a percentage of time during which the STA is to listen over the wireless communication link according to the operating channel BW setting for the STA while no transmission or reception of the traffic is performed.

8. The apparatus of claim 1, wherein the link-usage parameter is based on a Throughput (TPT) requirement corresponding to the traffic to be communicated between the STA and the AP over the wireless communication link.

9. The apparatus of claim 1 configured to cause the STA to determine the usage-based channel BW setting based on an available capacity of a Basic Service Set (BSS) of the AP.

10. The apparatus of claim 9 configured to cause the STA to determine the usage-based channel BW setting based on a condition that the available capacity of the BSS of the AP is to be maintained above a BSS capacity threshold.

11. The apparatus of claim 9 configured to cause the STA to determine the usage-based channel BW setting comprising a lowest supported channel BW, which is supported by the STA, and which complies with a condition corresponding to the link-usage parameter and the available capacity of the BSS.

12. The apparatus of claim 1 configured to cause the STA to determine the usage-based channel BW setting based on a power consumption of a radio of the STA to communicate over the wireless communication link according to the operating channel BW setting for the STA.

13. The apparatus of claim 1 configured to cause the STA to determine the usage-based channel BW setting to result in a first power consumption level of a radio of the STA for communication of the traffic, wherein the first power consumption level is lower than a second power consumption level of the radio of STA for communication of the traffic over the available channel BW of the STA.

14. The apparatus of claim 1 configured to cause the STA to select the usage-based channel BW setting from a plurality of supported channel BWs, which are supported by the STA, based on the link-usage parameter.

15. The apparatus of claim 1 configured to cause the STA to set the channel BW reduction request by setting a channel width subfield based on the usage-based channel BW setting, and setting the channel width subfield in an Operating mode (OM) control subfield to be transmitted from the STA to the AP.

16. The apparatus of claim 1 configured to cause the STA to determine the usage-based channel BW setting comprising a lowest supported channel BW, which is supported by the STA, and which complies with a condition corresponding to the link-usage parameter.

17. The apparatus of claim 1 comprising a radio to communicate the traffic over the wireless communication link.

18. The apparatus of claim 17 comprising one or more antennas connected to the radio, and a processor to execute instructions of an operating system of the STA.

19. A product comprising one or more tangible computer-readable non-transitory storage media comprising instructions operable to, when executed by at least one processor, enable the at least one processor to cause a wireless communication Station (STA) to:
determine a usage-based channel Bandwidth (BW) setting based on a link-usage parameter corresponding to a usage of a wireless communication link for communication of traffic between the STA and an Access Point (AP); and
transmit a channel BW reduction request to the AP based on a determination that the usage-based channel BW setting is less than an operating channel BW setting for the STA, wherein the channel BW reduction request is configured to request the AP to reduce the operating channel BW setting for the STA based on the usage-based channel BW setting.

20. The product of claim 19, wherein the link-usage parameter is based on an activity of a radio of the STA to communicate over the wireless communication link according to the operating channel BW setting for the STA.
